(19) United States
(12) Patent Application Publication
(10) Pub. No.: US 2014/0192663 A1
(43) Pub. Date: Jul. 10, 2014

(54) Power Difference Between SCell and PCell in a Carrier Aggregation System

(71) Applicants: Claudio Rosa, Randers (DK); Petri Vasenkari, Turku (FI); Jarkko T. Koskela, Oulu (FI); Sari Nielsen, Espoo (FI); Esa Malkamäki, Espoo (FI); Olli Alanen, Vantaa (FI)

(72) Inventors: Claudio Rosa, Randers (DK); Petri Vasenkari, Turku (FI); Jarkko T. Koskela, Oulu (FI); Sari Nielsen, Espoo (FI); Esa Malkamäki, Espoo (FI); Olli Alanen, Vantaa (FI)

(21) Appl. No.: 14/009,915

(22) PCT Filed: Mar. 30, 2012
(86) PCT No.: PCT/EP2012/055826

§ 371 Date: Nov. 12, 2013

Related U.S. Application Data
(60) Provisional application No. 61/472,398, filed on Apr. 6, 2011.

(51) Int. Cl. H04W 24/02

(52) U.S. Cl. CPC H04W 24/02
USPC 370/252

(57) ABSTRACT

In accordance with an example embodiment of the present invention, a method is disclosed. Determining that downlink reception on a first CC is degraded due to interference caused by a second CC. In response to the determining, arranging UL signaling to inform a network of a quantitative power difference between the first and the second CC and further identifying which of the first or second CCs exhibits a higher power.

### CROSS REFERENCE TO RELATED APPLICATION

This application claims priority under 35 U.S.C. §119(e) to U.S. provisional patent application No. 61/472,398 filed Apr. 6, 2011 which is hereby incorporated by reference in its entirety.

### TECHNICAL FIELD

The exemplary and non-limiting embodiments of this invention relate generally to wireless communication systems, methods, devices and computer programs and, more specifically, relate to synchronization/timing alignment timers in a communication system which employs carrier aggregation.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
CA carrier aggregation
CC component carrier
CQI channel quality indication
DL downlink (eNB to UE)
eNB EUTRAN Node B (evolved Node B/base station)
E-UTRAN evolved UTRAN (LTE)
IRR image rejection ratio
LTE long term evolution
MCS modulation and coding scheme
PCell primary cell
RF radio frequency
RRH remote radio head
RSRP reference symbol received power
RSRQ reference symbol received quality
SCell secondary cell
SINR signal to interference-plus-noise ratio
UE user equipment
UL uplink (UE to eNB)
UTRAN universal terrestrial radio access network

A future release of 3GPP LTE (e.g., LTE-Advanced) is directed toward extending and optimizing the 3GPP LTE Release 8 radio access technologies to provide higher data rates at low cost. LTE-A will most likely be part of LTE Release 10 which is to be backward compatible with LTE Release 8 and to include bandwidth extensions beyond 20 MHz to enable those higher data rates. This bandwidth extension is to be done via CA, in which one or several Release 8 compatible carriers are aggregated together to form a larger system bandwidth. The FIG. 1 example shows five Release 8 compatible CCs aggregated to form one LTE Release 10 bandwidth spanning 100 MHz. Existing Release 8 terminals can receive and/or transmit on one of the CCs for backward compatibility, while future LTE-A terminals could potentially receive/transmit on multiple CCs at the same time to give the eNB greater scheduling flexibility while increasing data throughput.

In the CA system there is to be active for any given UE one PCell and possibly one or more SCells depending on throughput needs and overall traffic. FIG. 1 is a simplified overview only; some CA arrangements may have certain CCs as extension carriers only which are useful only as a SCell and which are not backward compatible; some may have the CCs frequency non-adjacent to one another, some CCs may be in unlicensed spectrum (e.g., industrial/scientific/medical ISM band, or television white-spaces), and some may have different CCs spanning a different bandwidth. Any given CC may also have different UL and DL bandwidths.

It is possible to configure a UE to aggregate a different number of CCs originating from the same eNB but potentially also from different eNBs. The latter is targeted towards future heterogeneous deployment scenarios in which a LTE hotspot operating in the coverage area of a macro (traditional) eNB is configured as a SCell while the macro eNB is configured as the PCell. The LTE hotspots may be implemented as stand-alone femto eNBs which coordinate with the macro eNB, or as RRHs under full control of the macro eNB or frequency selective repeaters which may be under various levels of macro eNB control. FIGS. 2A-C illustrate a few of these coverage scenarios which result in yet-unresolved problems for such multi-CC communications, particularly when the CCs are on the same band and especially when they are adjacent to one another (e.g., two frequency adjacent carriers within the same band). Each of those Figures illustrates three adjacent macro cells, with lighter shading indicating macro eNB coverage, darkened shading indication femto eNB (or RRH/repeater) coverage, and the darkest shading indicating overlapped and more robust wireless coverage.

At FIG. 2A the three macro eNBs each provide macro coverage, and each also utilize RRHs to provide improved throughput at hot spots. UE mobility is performed based on the macro coverage. For a deployment like FIG. 2A the macro eNB and the RRHs are likely to be operating on different bands (e.g. 800 MHz or 2 GHz for the macro coverage and 3.5 GHz for hotspot coverage. The RRHs can be aggregated with their underlying macro eNBs.

FIG. 2B is similar except that frequency selective repeaters are deployed to extend coverage for one of the carrier frequencies. It is expected that where coverage of the macro eNB and the frequency selective repeaters overlap the carriers can be aggregated.

FIG. 2C illustrates the macro eNB co-located with the femto eNBs but the femto eNB antennas are directed to the macro cell boundaries to increase throughput at the cell edge. The macro eNB provides sufficient coverage but the femto eNB potentially has holes (e.g., due to its larger path loss). Mobility is based on the macro eNB coverage, and the FIG. 2C deployment is more likely for the case in which the macro and femto coverage are on different bands as with FIG. 2A. It is also expected that the macro and femto coverage of the same macro eNB can be aggregated where the coverage overlaps.

The problem for the scenarios of FIGS. 2A-B, and possibly also of FIG. 2C, concerns a difference in power levels that a given UE receives on the PCell and the SCell. For simplicity assume the femto eNB/RRH/repeater transmits to that UE on the SCell and the macro eNB transmits to it on the PCell (and possibly also other SCells).

In the 3GPP development of CA it has previously been agreed that the UE receiver image rejection minimum requirement is 25 dB, i.e., the receiver has to be able to attenuate the image of the received signal at least 25 dB. For example document Tdoc R4-103677 (3GPP TSG-RAN WG4 Meeting 2010 AH#4; Xi'an, China; 11-15 Oct. 2010) provides analysis on the impact of power difference between component carriers in intraband carrier aggregation when received with a direct conversion receiver. Local oscillator imbalance leads to images such that PCell subcarriers are impacted by SCell subcarriers and vice versa. This already occurs when a direct conversion receiver is used to receive a release 8 or release 9 signal, but the power differences between component carriers are an additional effect when carrier aggregation is considered, and the maximum power difference which needs to be supported is an important attribute of carrier aggregation at system level. The maximum power difference which can be supported will directly have implications for the cost, power consumption and complexity of UE designs and should not be over specified. On the other hand, not being able to handle larger power differences means that certain CA deployment scenarios may not be feasible for intraband carrier aggregation, and this aspect may need to be discussed further in RAN4. RRM strategies such as ensuring that the PCell is always the strongest cell may be partially effective in mitigating problems, but they do not make the image disappear and the necessary delays in UE and network handover mean that there will still be instants when the SCell is stronger than the PCell, and PCell demodulation is significantly affected. Allowing RF retuning could still be one useful tool to avoid problems in case the SCell is deactivated, but further modelling would be necessary to understand the effectiveness and whether the PCell losses due to retuning, or the PCell losses due to image were greater. This would be scenario and traffic model dependent, so there might not be a definitive answer but there may be scenarios in which there are losses if RF retuning is not allowed. In addition, RF retuning in case of deactivated SCell would allow for some power savings although this might not be the main benefit, and it would seem difficult for RAN4 to reach consensus on this point. Also, other work could be beneficial to carry out in RAN4 in order to ensure that intraband carrier aggregation is properly specified. At a minimum, RAN4 should understand the power differences between component carriers which need to be supported and define RF requirements accordingly.

In practice this means that for example if the UE's received PCell power is 30 dB higher than the SCell power, then the noise leaking from the PCell is 5 dB higher than the actual SCell transmission. FIG. 3 illustrates this example, with received power increasing on the vertical scale. The problem lies in that interference coming from the stronger cell, the PCell in the FIG. 3 example, will impact the UE's reception and data throughput on the weaker CC. For a UE using a single direct conversion RF receiver for receiving both SCell and PCell residing on the same band (and even adjacent to each other), it could be that the received power difference of PCell and SCell is so high that it causes an interference to the lower powered cell reception. It can occur that this interference is so strong as to make reception on the interfered CC practically impossible. Even power differences lower than the image rejection ratio (IRR) are problematic: the received SINR starts to decrease when the “noise” level from the image starts to be higher than receiver interference and noise levels. The performance of the weaker CC starts to decrease, perhaps initially a more robust MCS can be used but if it continues then at some point the wireless link gets so poor that data transmission or control signaling is not possible.

Currently there is no way for the UE to inform the network that the power difference of the received CCs is so large that required image rejection is not enough and the image is causing one CC to interfere with another. If the network were aware of it the UE could with network approval deactivate the SCell, since the network must know which CCs are active for any given UE in order that control signaling or data is not sent to that UE on an un-activated CC.

But even if the SCell were de-activated, by LTE Release 10 protocols the UE would still need to perform occasional measurements on it. In 3GPP discussions the UE would not be allowed to optimize the reception bandwidth in such a way that when receiving only the PCell the UE's receiver is tuned only to the narrow PCell bandwidth and widen its receiver tuning when making measurements on a deactivated SCell. This is because the UE's re-tuning of its receiver causes a short time duration during which no RF reception is possible for the UE. So even if the SCell were de-activated, so long as re-tuning the UE receiver to exclude the SCell is not allowed this may lead to a situation in which a stronger SCell will prevent reception on the PCell for potentially a much longer time than any receiver re-tuning would take.

### SUMMARY

Various aspects of examples of the invention are set out in the claims.

According to a first aspect of the present invention, a method is disclosed. Determining that downlink reception on a first CC is degraded due to interference caused by a second CC. In response to the determining, arranging UL signaling to inform a network of a quantitative power difference between the first and the second CC and further identifying which of the first or second CCs exhibits a higher power.

According to a second aspect of the present invention, a method is disclosed. Determining that a power difference among first and second CCs exceeds a tolerance threshold, in which the tolerance threshold is specific for a user equipment. In response to the determining, arranging uplink signaling to inform a network at least that the tolerance threshold was exceeded.

According to a third aspect of the present invention, an apparatus is disclosed. The apparatus includes at least one processor, and at least one memory including computer program code. The at least one memory and the computer program code configured to, with the at least one processor, cause the apparatus to perform at least the following: determining that downlink reception on a first CC is degraded due to interference caused by a second CC. And in response to the determining, arranging UL signaling to inform a network of a quantitative power difference between the first and the second CC and further identifying which of the first or second CCs exhibits a higher power.

According to a fourth aspect of the present invention, a computer program is disclosed. The computer program includes code for determining that downlink reception on a first CC is degraded due to interference caused by a second CC. And code for arranging, in response to the determining, UL signaling to inform a network of a quantitative power difference between the first and the second CC and further identifying which of the first or second CCs exhibits a higher power;

when the computer program is run on a processor.

### BRIEF DESCRIPTION OF THE DRAWINGS

FIG. 1 is a schematic diagram illustrating one implementation for parsing radio spectrum of a LTE Release 10 carrier aggregation system into multiple component carriers each compatible with LTE Release 8.

FIGS. 2A-C illustrate schematically three different deployment scenarios for a heterogeneous network employing carrier aggregation which presents a reception problem for a UE, and which is resolved according to the exemplary embodiments presented herein.

FIG. 3 graphically differentiates power levels received at a UE on the PCell and on a SCell such as may result from any of the scenarios of FIGS. 2A-C.

FIGS. 4A-B are plots of the difference between a UE's RSRP on the PCell and on the SCell under various conditions according to simulations conducted by the inventors in quantifying the UE reception problem.

FIGS. 5 and 6 are logic flow diagrams that each illustrates the operation of a method, and a result of execution of computer program instructions embodied on a computer readable memory, in accordance with the exemplary embodiments of this invention.

FIG. 7 shows a simplified block diagram of certain apparatus according to various exemplary embodiments of the invention.

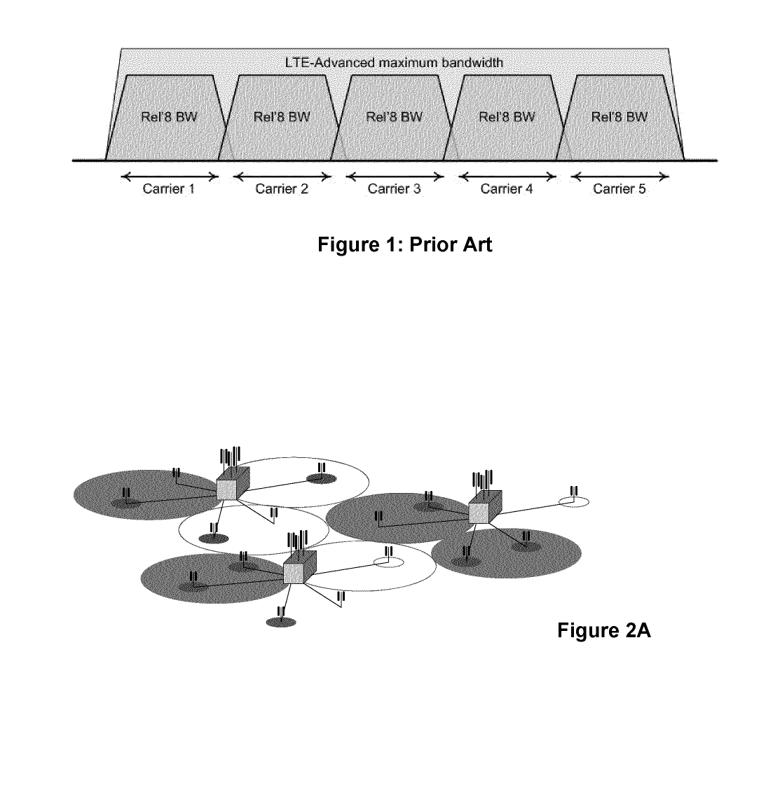

### DETAILED DESCRIPTION

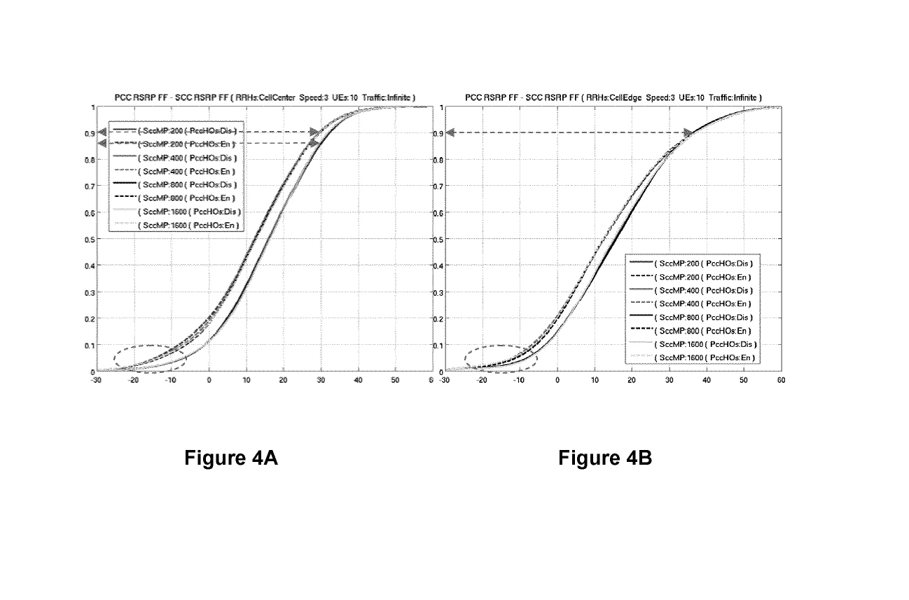

The examples below are in the context of a LTE Release 10 system but may be employed with any CA type wireless communication system. FIGS. 4A-B illustrate the inventors' quantitative modeling of the difference between a UE's RSRP on the PCell and on the SCell under various conditions. These simulation results reflect the disparate cases in which there is a PCell handover (PCCHOs:En means PCell handovers are enabled) as well as where there is not (PCCHOs:Dis means PCell handovers are disabled). Studying the data of FIGS. 4A-B reveals that even if the PCell is changed (using PCell handovers) from one (frequency) layer to another, when the SCell becomes stronger than the current PCell there is still significant power differences, and in some cases the RSRP of the PCell may even be weaker than the RSRP of the SCell. This is due to the fact that handover decisions require the filtering of measurement results for RSRP measurements.

Note from the legends of FIGS. 4A-B that certain practical aspects such as measurement reporting and handover delays are still not reflected, aspects which could even increase further the power differences between the PCell and the Scell. Additionally, the power differences in these system simulations are reported for Reference Symbol Received Power (RSRP) power differences which are unaffected by traffic and load differences between the PCell and the SCell(s), but in practice traffic and load conditions do have an effect on the UE's received power difference. The data at FIGS. 4A-B from the inventors' simulations therefore understates somewhat the differences which a UE would likely observe in a practical system.

In 3GPP TS 36.331 v10.1.0 (2011-03) there has been defined a measurement event A3 which is triggered when a neighbor cell offset is better (or worse) than the PCell. Superficially it seems this might be adapted to indicate to the network the power difference between the SCell and the PCell, thereby giving the network sufficient information to decide whether to deconfigure the SCell or handover to another CC. On further analysis this appears unworkable; the A3 reporting is triggered by offsets which are already known to the network but the image rejection characteristics are not uniform among any given pair of UEs. It appears quite impractical for the network to be able to set the offset values correctly to take UE-specific image rejection into account because to a certain extent the UE's image rejection characteristics are a function of the UE's RF architecture. Further, the event A3 is likely to be used for other purposes in the network and to adapt it for this use also would cause confusion on the network side as to which condition, neighbour cell or image interference, triggered any given event A3 report.

A similar difficulty arises if the network were to monitor for image rejection problems by looking into whether reported CQI measurements on the PCell or SCell drops and estimating that image rejection was the cause. But still network confusion arises because the CQI drop may arise from a coverage hole or other viable reasons apart from image rejection due to a received power differential.

Exemplary embodiments of the invention find the UE informing the network that it is experiencing an image interference, by UL signaling that includes a quantified power difference and also some indication which of the CCs is stronger (and by extension which one is weaker).

In this exemplary embodiment it is left to the UE to decide when image interference is a big enough problem that it needs to be indicated to the network. But the actual indication mechanism is in this embodiment standardized so that the network clearly knows that this image interference issue is causing problems, enabling the network to take appropriate actions to correct the situation and improve performance. Such post-reporting actions are detailed further below after detailing the reporting mechanism. In an embodiment the UL message reporting the image rejection problem is implemented in a wireless standard as a dedicated image problem trigger to be reported from the UE to network. While the report itself may be standardized, the exact trigger to send it depends in this embodiment on the UE's own decision of when the power differential is causing an image interference problem. What is standardized is the type of information in the report itself: some quantitative power difference between the PCell and the SCell, and also some identification of which of the PCell or SCell exhibits the higher power. Note that if implemented as an explicit bit indicating which CC exhibits the lower power, this is also an implicit indication that the other has the higher power.

By example, the UE could in one embodiment indicate that there is problem in receiving the PCell due to an image rejection problem caused by a stronger SCell; or alternatively the UE could indicate that there is problem in receiving the SCell due to an image rejection problem caused by a stronger PCell.

The report can also have an indication of how much stronger or weaker the stronger or weaker cell is; a quantitative power difference. In another embodiment the report informs the network how much the difference between the given SCell and PCell would need to change in order to improve the situation such that the performance degradation experienced by the UE would then be at an acceptable level (i.e., within the UE's image tolerance, which for LTE is derived from the image rejection requirements defined at 3GPP TS36.101 v10.2.0 (2011-03)). The underlying metric being quantified in these various embodiments of the report itself may be the RSRP power difference between the given SCell and PCell, or as the RSRQ difference between them, or even as the base station's transmit power difference for an embodiment in which the network provides to the UE the parameters needed for calculating the base station transmit powers based on the UE's own measurements on the downlinks.

Alternatively, the image problem indication could be simply indicating that there is a problem due to image interference. The network could then use earlier/other measurement results to discover which CC is stronger and how much and thus interfering with the weaker CC.

The above embodiments leave some freedom for the UE to decide when it actually has a reception problem due to image interference while still providing a uniform reporting so that regardless of which UE is reporting, the network can clearly know what actions are needed to address the problem.

In another embodiment a new measurement event is introduced to the 3GPP standards based on one or more of the existing measurement quantities, for example RSRP and/or RSRQ, to support this indication of an image rejection problem. This embodiment gives the network more control over when the UE triggers its report. Or alternatively this embodiment may utilize a new measurement parameter, similar to CQI so as to indicate that the UE's SNIR is impacted which is caused by some additional noise and/or interference due to image rejection problems.

By example, this embodiment may be somewhat similar to the event A3 noted above for conventional LTE, but this embodiment has an absolute threshold of the measurement parameter (e.g., RSRP, RSRQ) that needs to be fulfilled. For example, the UE would report if the measured parameter on the serving CC/PCell becomes worse than the absolute threshold parameter and the neighbor cell/SCell becomes offset better than the serving CC.

Utilizing RSRQ, RSRQ, some SNIR based measurement quantity or CQI, the interference characteristics of the UE which are dependent on the UE receiver structure are taken into account at least somewhat. The absolute threshold(s) for the reporting would in this embodiment be defined by the network, by utilizing the UE minimum image rejection requirement defined as noted above. There may be some UE implementations that do not suffer from image rejection problems due to their UE RF architecture, and the network might interpret their reports based on this absolute threshold as indicating an image rejection problem that does not exist, some manufacturers may prefer this option as it provides more parameter and threshold control for the network to control when an image rejection report is triggered.

The above embodiments are not mutually exclusive. For example, they may be combined either as separate events in which the UE reports when the SCell becomes e.g., 15 dB better than the PCell with a new event as detailed immediately above, and then the UE sends an indication when it determines its image interference is becoming a problem as first detailed above. Alternatively, these two embodiments may be combined such that the UE is allowed to send an UL report (or indication) of the problem only when the power difference between the SCell and the PCell is more than some predetermined (X dB) difference, in order to prevent unnecessary image interference reports.

Above are detailed various triggering mechanisms for the UE to send the interference report, and also various forms that interference report might take. To summarize, the reporting trigger may be specific to a particular model of a UE (due to its RF architecture) and/or it may be specific to how a UE implements its signal reception (e.g., software-controlled filtering). The various triggers may be the power difference between adjacent CCs surpassing a threshold, or interference on the weaker CC surpassing some threshold, or either of the above in addition to the power level measured on the weaker CC being above or below a threshold (above or below being for the alternate cases in which whether the weaker CC is the PCell or the SCell), or the power difference is above a first threshold while the interference level on the weaker CC is also above a second threshold. These are non-limiting examples of what the UE may use to trigger its sending of the UL interference report.

The various embodiments of the contents of the interference report itself include a simple indication (e.g., even just a single bit) that the triggering criteria have been met, or a quantitative indication of what the power difference is (either received power or calculated transmit power), of the interference report may provide the actual RSRP or RSRQ values the UE measured on the different CCs/cells. Either of the above quantitative measures can also be in a report that further includes the indication that the (one or more) triggering criteria has been met. Again, these are non-limiting examples of what information the interference report includes.

For any of the above embodiments, there are several options for how the network deals with the image interference of which it learns from the UE's UL interference report. In one embodiment the network deconfigures one of the cells which is causing the problem; in another embodiment the network can stop or suspend the UE's measurements of the SCell, such as by indicating in DL signaling that no measurements are needed for the SCell only, which the UE interprets as authorization to re-tune its receiver to receive the PCell only. This latter embodiment denies the network the ability to get further measurement results on the SCell and so it will have to rely on some other means for deciding whether to re-start measurements by that same UE on the SCell.

In still another embodiment of the network's response to the UE's image interference report, the network may indicate by explicit signaling (or it may be an automatic result for the UE of reporting its image interference problem) that the UE is allowed to re-tune its receivers to only receive the PCell, despite the above-noted short duration reception outage. Such explicit signaling may in various embodiments be RRC signaling (e.g., a reconfiguration message) or MAC signaling (e.g., the spare bit in the activation/deactivation MAC CE could in this case be used to indicate via one or more bits whether re-tuning is allowed). Alternatively the explicit signaling may be done prior to the network receiving the UE's image interference report. By example, the network can indicate at its configuration of the SCell (RRC signaling) that re-tuning is allowed when the corresponding cell is deactivated.

In certain scenarios the network may choose instead to handover the UE from the PCell to the stronger SCell in response to the UE's UL interference report. By example the network may signal this action to the UE via a handover command (e.g., a RRC reconfiguration message which includes mobility control information). While not expected to be a typical case since the handover was due to excessive interference among the CCs/cells, if the network retains the former PCell in the UE's configured and active set of CCs/cells after the handover, the network may also take any of the above actions (deconfigure, suspend measurements, allow re-tuning of the UE's receiver) concerning the former PCell.

The above responses are network directed actions to cure the image interference. In other embodiments the UE could autonomously take the corrective actions noted above, such as stopping/suspending its own measurements of the SCell and re-tuning its receiver to the PCell only. Such autonomous UE actions would in an embodiment still be under some control of the network (e.g., the network setting the thresholds, and/or configuring which actions are allowed), or at least in coordination with the network so the network can know what to expect concerning the UE's reception capability and/or future SCell measurement reports.

Another autonomous UE corrective action is to deconfigure the SCell and then re-tune to receive the PCell only. In this embodiment the UE's measurement of the SCell frequency would be based on measurement gaps and the re-tuning of the receiver would be “invisible” to the network. In one variation on this embodiment the UE also signals to the network that is going to deconfigure the corresponding SCell.

In another embodiment of the UE autonomous corrective action, the UE is allowed to retune its receiver to the PCell only autonomously when given conditions are met, e.g., such as when the power difference becomes more than some threshold (Y dBs). In this case the UE would receive only the PCell when the SCell is too strong, and still periodically retune its receiver to measure the SCell. In practice this means that for this UE PCell reception is not possible during the measurement, and so the UE could use autonomous measurement gaps (e.g., measure the SCell with a narrowband receiver tuned to the SCell frequency only).

These corrective actions also are not mutually exclusive; the network may follow one or more of the network-directed corrections and the UE is allowed to perform one or more of the UE autonomous corrective actions. The UE autonomous corrective actions may be allowed by standardized requirements. An example of this is that if the network deployment scenarios are such that power differences between the PCell and the SCell are larger than what the UE can tolerate based on the standardized minimum image rejection requirements (currently 25 dB IRR is agreed in the 3GPP RAN4 working group), then the UE is autonomously allowed to take certain corrective actions such as those detailed above.

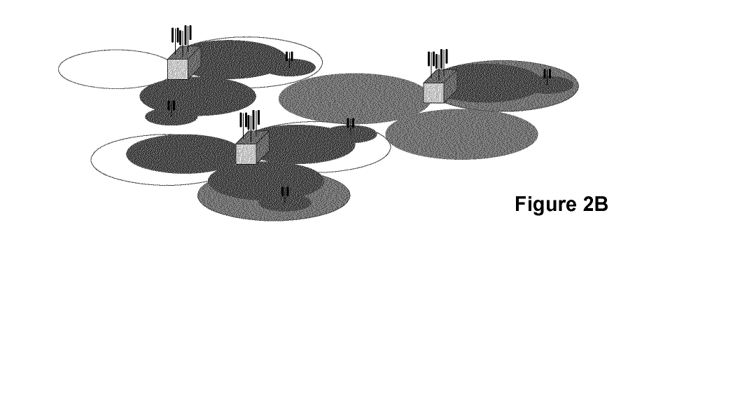

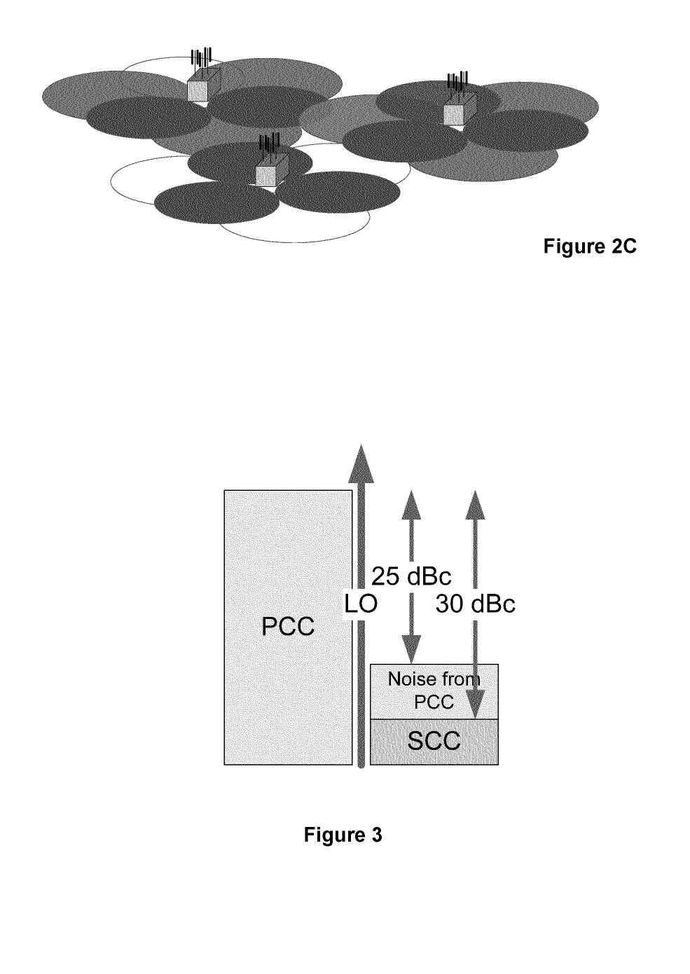

In another embodiment similar to the corrective actions above, the network can indicate, independent of any image interference report, whether or not the UE is allowed to re-tune its receiver to the PCell only (and for a short time during which the receiver is re-tuned be unable to receive on the PCell), but this allowance is restricted to only certain coverage scenarios (e.g., FIGS. 2A-C), or anytime the UE is not under coverage of a RRH.

In this embodiment the network can simply indicate that re-tuning of the UE's receiver is allowed and then such re-tuning is allowed always. Alternatively this can indicate that receiver re-tuning is allowed only if certain rules (e.g., some measurement event such as those detailed above) are fulfilled. Such a measurement event does not necessarily need to trigger the UE to send an image interference report to the network, but the network may allow such a report to know when it can expect the resulting UE reception outages on the PCell.

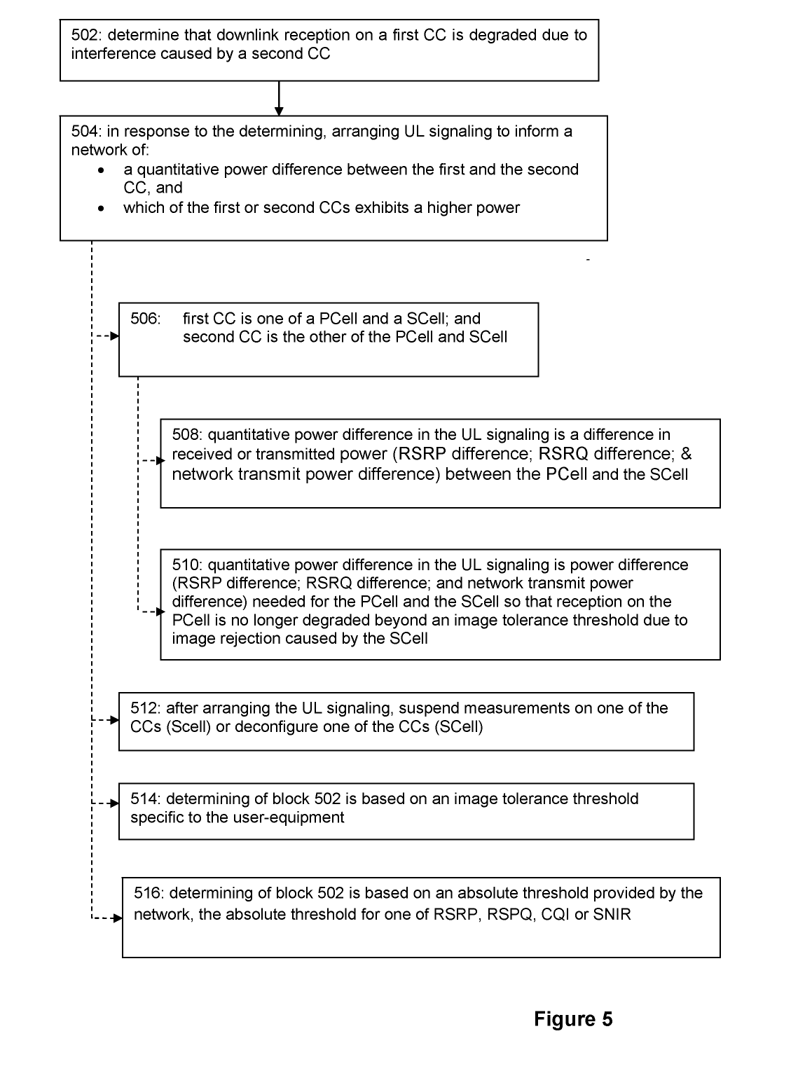

The flow diagram of FIG. 5 illustrates some of the above exemplary embodiments from the perspective of the UE, but the reader will recognize that the network access node will follow similar steps as are outlined above. The UE at block 502 determines that downlink reception on a first CC is degraded due to interference caused by a second CC, and at block 504 in response to the determining the UE arranges UL signaling to inform a network of a quantitative power difference between the first and the second CC and further identifying which of the first or second CCs exhibits a higher power. In an embodiment the degradation at block 502 is due to image interference.

Further elements of FIG. 5 shown by dashed lines indicate one of more of the various options detailed above. At block 506 the first CC is one of a primary CC/PCell and a secondary CC/SCell, and the second CC is the other of the primary CC/PCell and the secondary CC/SCell. Blocks 508 and 510 give two alternatives for the quantitative power difference mentioned at block 504. At block 508 it is informed in the UL signaling of block 504 as a difference in received or transmitted power between the primary CC/PCell and the secondary CC/SCell. At block 510 it is informed in the UL signaling of block 504 as a power difference needed for the first or the second CC so that reception on the first CC/PCell is no longer degraded beyond an image tolerance threshold due to image rejection caused by the second CC/SCell.

Block 512 of FIG. 5 gives two embodiments of the corrective actions noted above: after arranging the UL signaling of block 504 then either measurements are suspended on one of the CCs (the SCell) or one of the CCs (the SCell) is de-configured. Blocks 514 and 516 give different embodiments of what triggers sending of the image interference report, which is the determining of block 502. In the block 514 embodiment the determination of block 502 is based on an image tolerance threshold specific to the user-equipment. In the block 514 embodiment it is based on an absolute threshold provided by the network, the absolute threshold being a threshold for one of RSRP, RSPQ, CQI or SNIR.

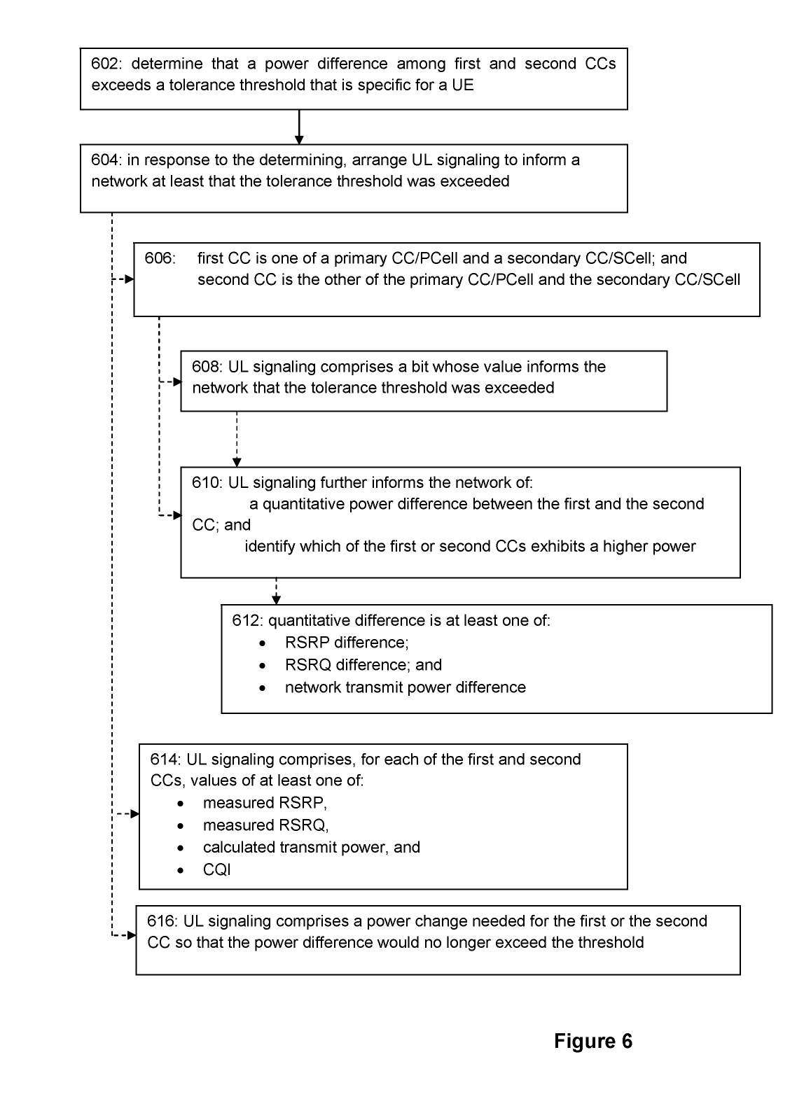

The flow diagram of FIG. 6 also illustrates certain of the above exemplary embodiments from the perspective of the UE, with the network access node following similar steps as are outlined above. The UE at block 602 determines that a power difference among first and second CCs exceeds a tolerance threshold. In this embodiment the tolerance threshold is specific for a user equipment, such as due to its RF architecture or UE specific implementation as noted above. UE-specific in this case refers to more than simply dependent on values sent to the particular UE by the network. Then at block 604 the UE, in response to the determining, arranges uplink signaling to inform a network at least that the tolerance threshold was exceeded. The signaling is arranged at block 604 and not necessarily sent yet, and so blocks 602 and 604 may be practiced by one or more components of the UE apart from the actual radio transmitter.

Further elements of FIG. 6 shown by dashed lines indicate one of more of the various options detailed above. At block 606 the first CC is one of a primary CC/PCell and a secondary CC/SCell, and the second CC is the other of the primary CC/PCell and the secondary CC/SCell. Block 608 further details block 606 in that the uplink signaling comprises a bit (or more than just one) whose value informs the network that the tolerance threshold was exceeded. Block 610, which may or may not be combined with block 608, specifies that the UL signaling is further arranged to inform the network of a quantitative power difference between the first and the second CC and to further identify which of the first or second CCs exhibits a higher power. As noted above, a bit that explicitly tells which CC/cell has the lower power also implicitly tells which CC/cell has the higher power. This quantitative difference of block 610 is further specified at block 612 in that it comprises at least one of: RSRP difference; RSRQ difference; and network transmit power difference.

Block 614 represents the embodiment in which the uplink signaling comprises, for each of the first and second CCs, values of at least one of: measured RSRP, measured RSRQ, calculated transmit power, and CQI. Block 616 illustrates the embodiment in which the uplink signaling comprises a power change needed for the first or the second CC so that the power difference would no longer exceed the threshold of block 602.

The various actions, taken by the UE autonomously or initiated by the network, are not particularly detailed at FIG. 6 but are detailed above.

FIGS. 5 and 6 may each be considered to be a logic flow diagram that illustrates the operation of a method, and a result of execution of computer program instructions, in accordance with the exemplary embodiments of this invention, such as for example from the perspective of the UE. The various blocks shown in FIGS. 5 and 6 may be viewed as method steps, and/or as operations that result from operation of computer program code, and/or as a plurality of coupled logic circuit elements constructed to carry out the associated function(s).

For example, the UE or one or more components thereof can form an apparatus comprising at least one processor and at least one memory including computer program code, in which the at least one memory and the computer program code are configured to, with the at least one processor, cause the apparatus to perform the elements shown at FIG. 5 or FIG. 6 and/or recited in further detail above.

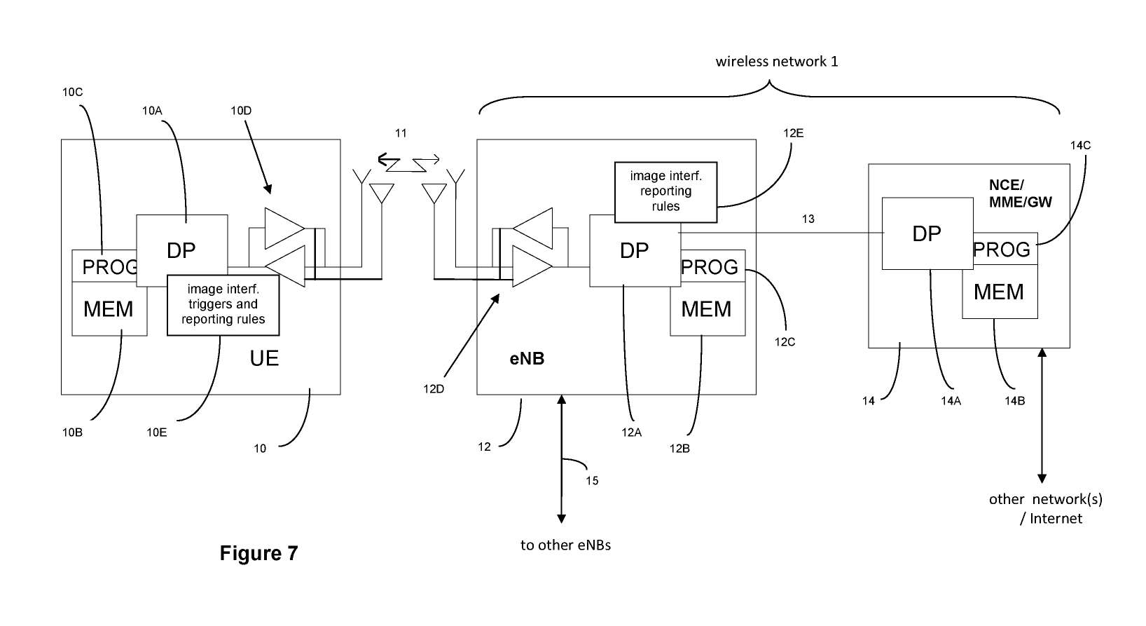

FIG. 7 illustrates a simplified block diagram of various electronic devices and apparatus that are suitable for use in practicing the exemplary embodiments of this invention. In FIG. 7 a wireless network 1 is adapted for communication over a wireless link 11 with an apparatus, such as a mobile communication device which above is referred to as a UE 10, via a network access node, such as a Node B (base station), and more specifically an eNB 12. The network 1 may include a network control element (NCE) 14 that may include the mobility entity/serving gateway MME/S-GW functionality known in the LTE system, and which provides connectivity with another network, such as a telephone network and/or a data communications network (e.g., the internet).

The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transceiver 10D for bidirectional wireless communications with the eNB 12 via one or more antennas. The eNB 12 also includes a controller, such as a computer or a data processor (DP) 12A, a computer-readable memory medium embodied as a memory (MEM) 12B that stores a program of computer instructions (PROG) 12C, and a suitable RF transceiver 12D for communication with the UE 10 via one or more antennas. The eNB 12 is coupled via a data/control path 13 to the NCE 14. The path 13 may be implemented as the S1 interface known in LTE. The eNB 12 may also be coupled to another eNB via data/control path 15, which may be implemented as the X2 interface known in LTE.

At least one of the PROGs 10C and 12C is assumed to include program instructions that, when executed by the associated DP, enable the device to operate in accordance with the exemplary embodiments of this invention, as detailed above.

That is, the exemplary embodiments of this invention may be implemented at least in part by computer software executable by the DP 10A of the UE 10 and/or by the DP 12A of the eNB 12, or by hardware, or by a combination of software and hardware (and firmware).

For the purposes of describing the exemplary embodiments of this invention the UE 10 may be assumed to also include image interference reporting triggers and rules for how to construct that report, shown generally at block 10E. The eNB also has a block 12E storing the image interference reporting rules so it can properly detect the content of the UE's UL image interference report and know that it is reporting on image interference.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMS 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multicore processor architecture, as non-limiting examples.

Below are provided further descriptions of various non-limiting, exemplary embodiments. The below-described exemplary embodiments may be practiced in conjunction with one or more other aspects or exemplary embodiments. That is, the exemplary embodiments of the invention, such as those described immediately below, may be implemented, practiced or utilized in any combination (e.g., any combination that is suitable, practicable and/or feasible) and are not limited only to those combinations described herein and/or included in the appended claims.

In one exemplary embodiment, an apparatus comprising at least one processor, and at least one memory including computer program code. The at least one memory and the computer program code configured to, with the at least one processor, cause the apparatus to perform at least the following: determining that downlink reception on a first CC is degraded due to interference caused by a second CC. And in response to the determining, arranging UL signaling to inform a network of a quantitative power difference between the first and the second CC and further identifying which of the first or second CCs exhibits a higher power.

An apparatus as above, in which the first CC is one of a primary CC and a secondary CC, and the second CC is the other of the primary CC and the secondary CC.

An apparatus as above, in which the quantitative power difference is informed in the UL signaling as a difference in received or transmitted power between the primary CC and the second CC.

In another exemplary embodiment, a computer program comprising code for determining that downlink reception on a first CC is degraded due to interference caused by a second CC. And code for arranging, in response to the determining, UL signaling to inform a network of a quantitative power difference between the first and the second CC and further identifying which of the first or second CCs exhibits a higher power, when the computer program is run on a processor.

A computer program as above wherein the computer program is a computer program product comprising a computer-readable medium bearing computer program code embodied therein for use with a computer.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention. Some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
determining that downlink reception on a first CC is degraded due to interference caused by a second CC; and
in response to the determining, arranging UL signaling to inform a network of a quantitative power difference between the first and the second CC and further identifying which of the first or second CCs exhibits a higher power.

2. The method according to claim 1, in which the first CC is one of a primary CC and a secondary CC, and the second CC is the other of the primary CC and the secondary CC.

3. The method according to claim 2, in which the quantitative power difference is informed in the UL signaling as a difference in received or transmitted power between the primary CC and the second CC.

4. The method according to claim 2, in which the quantitative power difference is informed in the UL signaling as a power difference needed for the first or the second CC so that reception on the first CC is no longer degraded beyond an image tolerance threshold due to image interference caused by the second CC.

5. The method according to claim 3, in which the quantitative power difference comprises at least one of: RSRP difference; RSRQ difference; and network transmit power difference; and the interference is image interference.

6. The method according to claim 2, the method further comprising: after arranging the UL signaling, one of suspending measurements on the secondary CC or deconfiguring the secondary CC.

7. The method according to claim 1, in which the method is executed by a user equipment and the determining that downlink reception on the first CC is degraded due to interference caused by the second CC is based on an image tolerance threshold specific to the user-equipment.

8. The method according to claim 1, in which the determining that downlink reception on the first CC is degraded due to interference caused by the second CC is based on an absolute threshold provided by the network, the absolute threshold for one of RSRP, RSPQ, CQI or SNIR.

9. A method comprising:
determining that a power difference among first and second CCs exceeds a tolerance threshold, in which the tolerance threshold is specific for a user equipment; and
in response to the determining, arranging uplink signaling to inform a network at least that the tolerance threshold was exceeded.

10. The method according to claim 9, in which the first CC is one of a primary CC/PCell and a secondary CC/SCell, and the second CC is the other of the primary CC/PCell and the secondary CC/SCell.

11. The method according to claim 10, in which the uplink signaling comprises a bit whose value informs the network that the tolerance threshold was exceeded.

12. The method of claim 10, in which the UL signaling is further arranged to inform the network of a quantitative power difference between the first and the second CC and to further identify which of the first or second CCs exhibits a higher power.

13. The method according to claim 12, in which the quantitative power difference comprises at least one of: RSRP difference; RSRQ difference; and network transmit power difference.

14. The method according to claim 9, in which the uplink signaling comprises, for each of the first and second CCs, values of at least one of: measured RSRP, measured RSRQ, calculated transmit power, and CQI.

15. The method according to claim 9, in which the uplink signaling comprises a power change needed for the first or the second CC so that the power difference would no longer exceed the threshold.

16. An apparatus, comprising:
at least one processor; and
at least one memory including computer program code
the at least one memory and the computer program code configured to, with the at least one processor, cause the apparatus to perform at least the following: determining that downlink reception on a first CC is degraded due to interference caused by a second CC; and
in response to the determining, arranging UL signaling to inform a network of a quantitative power difference between the first and the second CC and further identifying which of the first or second CCs exhibits a higher power.

17. The apparatus according to claim 16, in which the first CC is one of a primary CC and a secondary CC, and the second CC is the other of the primary CC and the secondary CC.

18. The apparatus according to claim 17, in which the quantitative power difference is informed in the UL signaling as a difference in received or transmitted power between the primary CC and the second CC.

19. A computer program, comprising:
code for determining that downlink reception on a first CC is degraded due to interference caused by a second CC; and
code for arranging, in response to the determining, UL signaling to inform a network of a quantitative power difference between the first and the second CC and further identifying which of the first or second CCs exhibits a higher power; when the computer program is run on a processor.

20. The computer program according to claim 19, wherein the computer program is a computer program product comprising a computer-readable medium bearing computer program code embodied therein for use with a computer.
